(19) United States
(12) Patent Application Publication
(10) Pub. No.: US 2007/0099006 A1
(43) Pub. Date: May 3, 2007

(54) Highly compliant bonding compound and structure

(75) Inventors: Dov Ingman, Haifa (IL); Ephraim Suhir, Los Altos, CA (US)

Correspondence Address: BARDMESSER LAW GROUP, P.C., 910 17TH STREET, N.W., SUITE 800, WASHINGTON, DC, 20006, US

(73) Assignee: ERS Company, Los Altos, CA (US)

(21) Appl. No.: 11/264,097

(22) Filed: Nov. 2, 2005

(51) Int. Cl. B32B 27/00; C09J 183/04; C08L 83/04

(52) U.S. Cl. 428/447; 156/329; 524/588

(57) ABSTRACT

A compliant bonding material includes a thixotropic filler, and a plurality of nanoparticles embedded in the filler. The filler can be for example, oil or other stable viscous liquid with the proper surface tension properties, for example, siloxane, other silicone oils, or polysiloxane. The nanoparticles can be, e.g., Ag, Cu, Ti, Ni, metal oxides, silica, ZnO and Fe₂O₃. A plurality of microspheres can be embedded in the filler, with whiskers formed on surfaces of the microspheres. Nanoparticles can also be embedded in the filler. The whiskers can be nanotubes, nanoparticles and/or nanowires. The whiskers can be, for example, metallic. The bonding material can be used a bonded structure that includes a first surface and a second surface, with the bonding material positioned between the first and second surfaces.

### BACKGROUND OF THE INVENTION

1. Field of the Invention

The present invention is generally directed to bonded assemblies (joints) and, more specifically, the invention relates to bonded assemblies (joints) used in micro- and opto-electronics, and in photonics.

2. Discussion of the Related Art

Bonded assemblies (joints) subjected to thermal and/or mechanical loading are widely used in engineering. The most reliable adhesively bonded or soldered assemblies are characterized by stiff adherends and a compliant (to the extent possible) bonding layer. Low modulus and relatively thick (up to 4 mils or even thicker) bonding layers are employed in micro- and opto-electronics in order to provide a desirable strain buffer between the adherend materials. These are typically subjected to thermally induced stresses due to the thermal expansion (contraction) mismatch between dissimilar materials of the adherends, as well as due to temperature gradients caused by an operating chip. In many other cases, adhesively bonded, soldered or otherwise bonded joints are subjected to mechanical loading.

Accordingly, there is a need in the art for better bonding materials and structures that combine good adhesive properties with high compliance. In this connection it should be point out that reliable adhesion in a bonded assembly (joint) is due to both high bearing capacity of the joint (i.e., its ability to withstand high stresses of any nature), as well as to the low level of loading, which is supposed to be always lower than the level of the bearing capacity of the structure. High compliance of the adhesive layer is aimed at reducing the level of the loading, thereby making sufficiently reliably even those joints whose bearing capacity might not be very high.

### SUMMARY OF THE INVENTION

Accordingly, the present invention is related to a highly compliant bonding compound and structure that substantially obviates one or more of the disadvantages of the related art.

In one aspect of the invention, there is provided a bonding material including a thixotropic filler (matrix), and a plurality of nanoparticles embedded in the matrix. The material is a compliant bonding material. The nanoparticles can be, e.g., any of Ag, Cu, Ti, Ni, metal oxides, silica, ZnO and Fe₂O₃.

In another aspect of the invention, there is provided a bonding material including a thixotropic matrix, and a plurality of microspheres embedded in the matrix. A plurality of protrusions (e.g., “whiskers”) are formed on the surfaces of the microspheres. Nanoparticles can also be embedded in the matrix. The protrusions can be nanotubes, nanoparticles and/or nanowires. The whiskers can be, for example, metallic. It should be pointed out that the employment of metal protrusions, wires, whiskers or metal nano-particles, or the use of other highly thermally conductive materials in the bonding layer, not only increases the compliance of this layer, but leads to a lower difference, if any, in temperature between the bonded components, thereby reducing the effective thermal expansion/contraction mismatch of the dissimilar materials of the adherends.

In another aspect, a bonded structure includes a first surface and a second surface. A thixotropic compliant bonding material is positioned between the first and second surfaces. The bonding material includes nanoparticles.

In another aspect, a bonded structure includes a first surface and a second surface. A substrate is between the first and the second surfaces, the substrate having any of nanowires and nanotubes formed on at least one side (or, optionally, both sides), the nanowires and/or nanotubes being in contact with the first and the second surfaces. The nanotubes and nanowires can be subjected to axial compression, which is due to an externally applied force.

Additional features and advantages of the invention will be set forth in the description that follows, and in part will be apparent from the description, or may be learned by practice of the invention. The advantages of the invention will be realized and attained by the structure particularly pointed out in the written description and claims hereof as well as the appended drawings.

It is to be understood that both the foregoing general description and the following detailed description are exemplary and explanatory and are intended to provide further explanation of the invention as claimed.

### BRIEF DESCRIPTION OF THE ATTACHED FIGURES

The accompanying drawings, which are included to provide a further understanding of the invention and are incorporated in and constitute a part of this specification, illustrate embodiments of the invention and together with the description serve to explain the principles of the invention.

In the drawings:

FIG. 1 shows the plot of the dependence of the space between the bonded surfaces vs. the radius of the bonding material—bond contact area.

FIG. 2 shows a plot of the space between the bonded surfaces vs. bond contact area.

FIG. 3 shows a plot of the compound-air interface area vs. bond-surface.

FIG. 4 shows energy relationships plotted for different k-values.

FIG. 5 shows nanotubes on a bonded surface.

FIG. 6 shows nanotubes attachment at one end to the bonded surface.

FIG. 7 shows an example of a bonding material based on nanotubes plus filler only, with only the nanotubes shown in the figure, before addition of the filler.

FIG. 8 shows a nanotube structure in the bonding material with microspheres.

FIG. 9 shows a bonding material structure with nanowires and nanoparticles.

FIG. 10 shows a bonding material with microspheres and nanoparticles

FIG. 11 shows self-organizing of the microspheres with protrusions/whiskers (nanoparticles).

FIG. 12 shows formation of microspheres with protrusions (nanoparticles).

FIG. 13 shows a schematic of the microspheres/microparticles with protrusions/whiskers.

### DETAILED DESCRIPTION OF THE PREFERRED EMBODIMENTS

Reference will now be made in detail to the preferred embodiments of the present invention, examples of which are illustrated in the accompanying drawings.

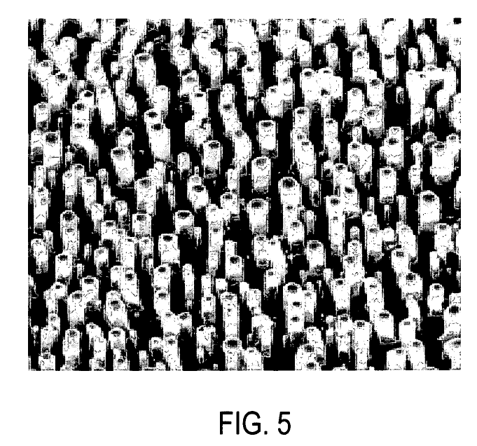

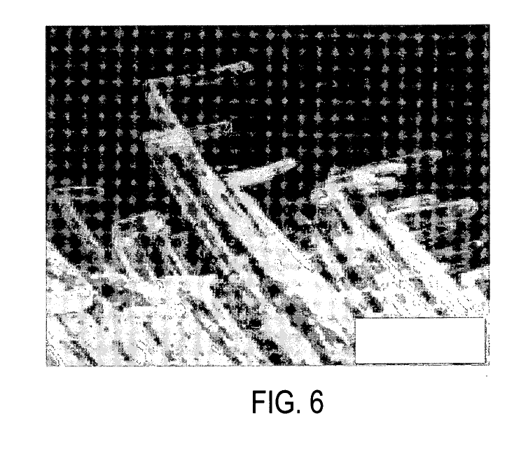

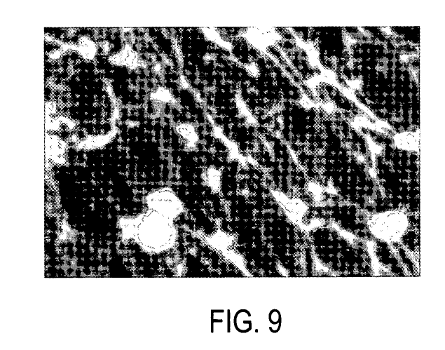

The present invention generally relates to a highly compliant bonding structure and material. This structure can be based on 1) using nanowire (nano-tubes, nano-rods, nano-beams, etc.) arrays (see, e.g., FIG. 9, which shows a bonding material structure with nanowires and nanoparticles) as a compliant attachment (strain buffer) and/or on 2) the application of a “smart” nanoparticle-based structure that exhibits thixotropic properties. The nanowires or nanotubes can be grown by any existing method, such as plasma, CVD, etc. FIG. 5 shows nanotubes on a bonded surface. FIG. 6 shows nanotubes attached at one of their ends to the bonded surface. Note that in these photographs, the filler material is not shown (since it would be impossible to see anything if the filler material were there).

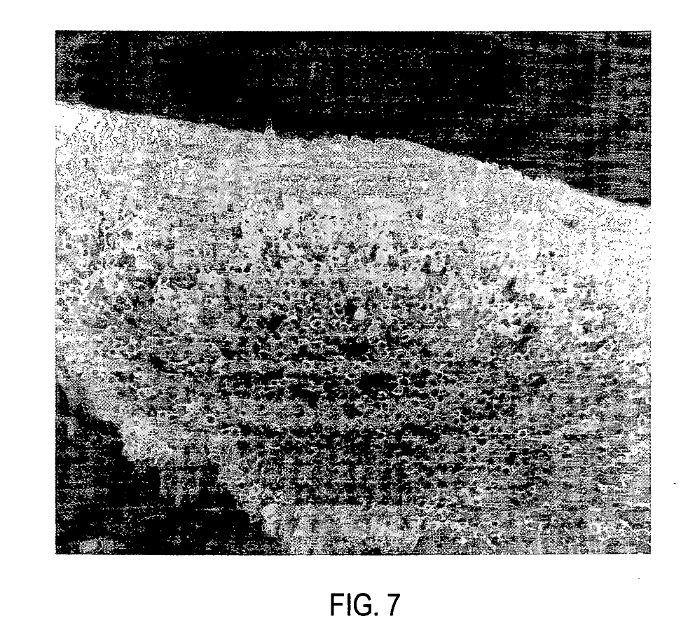

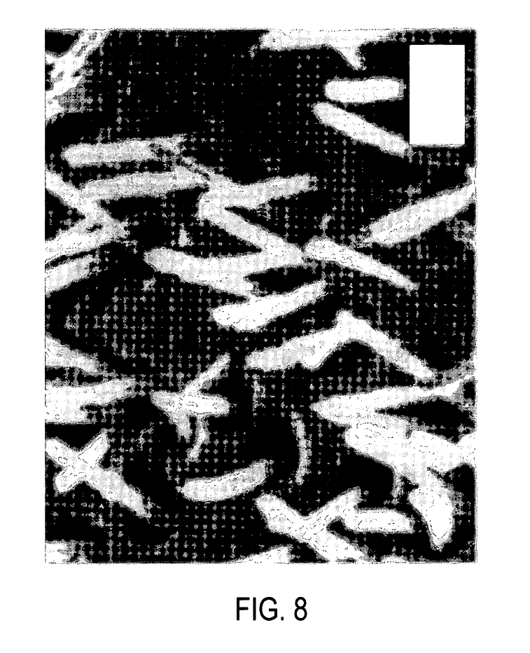

FIG. 7 shows an example of a bonding material based on nanotubes plus filler only, with only the nanotubes shown in the figure, before the filler is added to the structure. FIG. 8 shows a nanotube structure in the bonding material with microspheres—in this case the surface density of nanotubes is 10-20 times lower than in FIG. 7.

In one embodiment, the nanowires or nanotubes are employed to manufacture a compliant attachment. In another embodiment, a low modulus, a low-viscosity and a thixotropic filler (matrix) is used to fill in the space between the nanowires. Polysiloxanes and silicone gels are examples of matrix (filler) materials. The filler (matrix) should wet the surface of the nanowires, have a sufficiently low viscosity, but, preferably, should possess thixotropic properties. These properties can be achieved by filling the matrix with suitable nanoparticles.

Thus, a highly compliant bonding compound and structure with thixotropic properties of the bonding material is disclosed. Thixotropy (change in viscosity when subjected to stress or other disturbance) is achieved by employing a viscous matrix, optionally containing appropriate nanoparticles. The material of the matrix should have good enough adhesion to bonding surfaces. The nanoparticles could be of any physical nature or configuration, e.g., could be circular, flat, elliptical, etc., and the two bonded surfaces do not have to be necessarily of the same configuration, for example, a circular surface could be adhered to a flat surface.

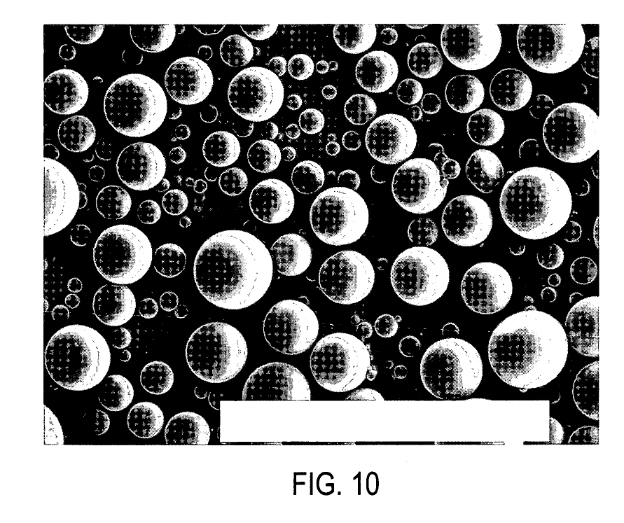

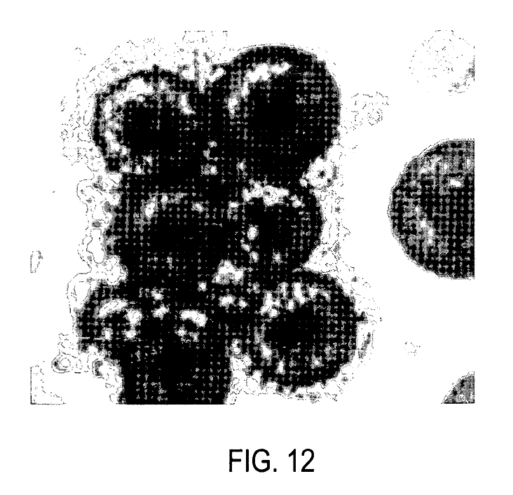

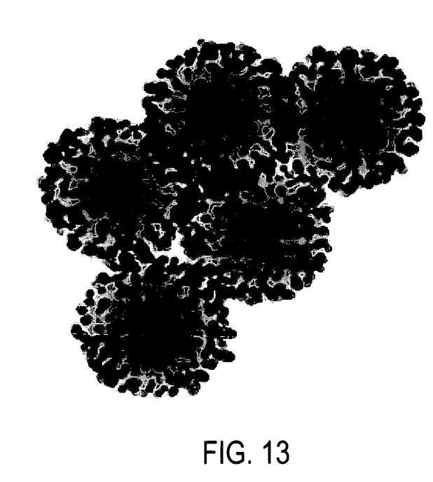

The matrix may also contain microspheres and/or microparticles and/or nanotubes and/or nanowires. Examples of microspheres are shown in, e.g., FIG. 10, which shows a bonding material with microspheres and nanoparticles. FIG. 11 shows self-organizing of the microspheres with protrusions (whiskers, nano-particles, etc.). FIG. 12 shows formation of microspheres with protrusions (nanoparticles).

The nanotubes and/or nanowires are grown on at least one of the bonded surfaces. Alternatively, the nanotubes and/or the nanowires can be grown on both sides of a separate foil (substrate), which is then positioned between the bonded surfaces. Both embodiments could be combined, so that the bonding structure employs nanotubes and/or the nanowires grown (or otherwise fabricated) on the inner surfaces of the bonded components, as well as an “inserted” foil (substrate) with nanotubes and/or nanowires grown (or otherwise fabricated) on at least one of the sides of the foil.

Nanotubes and/or nanowires could be subjected to externally and/or internally deliberately produced axial compression for even higher lateral compliance. Axial compression increases lateral compliance and, in an extreme case, such a compression even causes bending due to buckling, i.e., even with no lateral loading at all. In circular or elliptical bonded structures (such as coated optical fibers or cables), the compression arises because of the thermal contraction mismatch in the radial direction of the high CTE (coefficient of the thermal expansion) coating and low CTE cladding. This leads to “hoop” stresses. In flat bonded joints, as has been indicated, the axial compression could be introduced deliberately (externally or internally) for greater lateral compliance of the nanotubes and/or nanowires.

Consider two bonding surfaces (e.g., parallel surfaces, though in the general case, as has been indicated, they need not be parallel) and a drop of the bonding material placed between the surfaces in such a way that this drop touches the bonding surfaces. In other words, a portion of the drop surface touches the bonding surfaces and the remainder of the drop's surface is “free”, i.e., is in contact with air. If the affinity of the bonding material's, the surface tension in the portions of the bonding material, which are in contact with the bonding surface, is higher than the surface tension in the portions of the bonding material, which is in contact with air. As a consequence of that, the bonding material, in order to minimize the potential elastic energy of the drop's surface, will tend to increase the contact area with the bonding surfaces and to decrease the contact area with air. As a result of that the drop of the bonding material will trend to assume a different shape—to be “pita-like,” as if it is “compressed” between the bonding surfaces. The material will tend to decrease the contact area with air and increase the contact area with the bonding surfaces (the total volume of the boning material stays the same). The described process of “self-deformation” and “self-adjustment” that leads to the bonding surfaces' getting closer to each other does not continue indefinitely. It eventually reaches a point, when the potential energy (as a function of the distance between the surfaces) becomes minimal. This minimum is a function of the ratio between the surface tension coefficients at the material-air boundary and the material-adherends boundaries. The higher this ratio, the higher is the bonding material-bonding surface contact area and the smaller the is the distance between the bonded surfaces. If the distance between the bonding surfaces at a certain moment of time becomes larger than the minimum distance that corresponds to the minimum elastic energy, then the bonding material performs as a sort of a stretched spring, trying to bring the bonded surfaces closer, i.e, providing axial compression that is proportional to the derivative of the elastic energy with respect to the distance between the bonded surfaces.

The “whiskers”, nano-tubes, nano-wires and microspheres serve as spacers and as a type of compressed “springs,” so that the equilibrium distance between the bonded surfaces corresponds to the equilibrium between the compressing forces of the thixotropic compound provided by the difference in the surface tension coefficients and the elastic forces of the “spacers” (whiskers, microspheres, etc.) of compressed elements and/or bent nanotubes or nanowires. This repulsive force is proportional to the deformation, individual elastic properties of microspheres and/or nanotubes and to their surface density (number of elements per unit bond contact area). Therefore, the combination of the compressing features of the bonding material filler and the elastic properties of microspheres, nanowires and/or nanotubes, as well as their density in the bonding compound uniquely define, in a controllable manner, the distance between the bonded surfaces.

In yet another embodiment, the microspheres and/or the microparticles may have protrusions on their surfaces. These protrusions (e.g., “whiskers”) could be nanotubes and/or nanowires, and/or nanoparticles, which are adhered to the microspheres and/or to the microparticles with at least one of their ends (or with a small portion of their external surface). The protrusions could be made of either metallic or non-metallic materials. In addition to the structural compliance of the nanotubes and/or the nanowires, the disclosed structure possesses high compliance also because of, and, in many cases, primarily owing to, its thixotropic matrix. The nanoparticle material of the matrix, which is quasi-solid in the absence of the applied stress field (disturbance), becomes much less viscous, and even quasi-liquid. Hence, the assembly becomes much more compliant as a result of being subjected to mechanical or thermal loading. The disclosed structure provides a highly effective strain buffer between the adherend components.

The objective of the analytical stress model that follows is to evaluate the effect of the interfacial compliance of the bonding layer on the level of the interfacial shearing stress and to demonstrate (illustrate) the importance of introducing and employing compliant bonds. This could certainly be done in addition to, or sometime even instead of, employing adherends with low thermal extension (contraction) mismatch. The model that follows is used merely as an illustration, and is intended to show that the maximum interfacial shearing stress is inversely proportional to the square root of the interfacial compliance. The interfacial compliance is due, generally, to the compliance of the bonding layer, as well as to the interfacial compliances of the bonded materials (components) themselves.

As follows from the analysis below, the compliances of the bonding layer and the adherends can be added together when the total interfacial compliance is evaluated. For this reason, it should be pointed out that if a highly compliant bonding layer is employed, it is only this layer, and not the adherends, that is primarily responsible for the interfacial compliance of the bond, and, hence, for the structural reliability of the joint. These considerations are equally applicable to any assembly configuration, whether circular (e.g., in fiber optics applications), flat (e.g., in microelectronics applications), elliptical, etc. Thus, if a highly compliant attachment is used, the bonding joint becomes much less sensitive to the compliance of the adherend components themselves, which is always a “plus” for any structural design: one does not have to worry nor to consider the compliance of the adherend materials.

The following major assumptions are used in the analysis:
(1) Approximate methods of structural analysis (strength-of-materials) and materials science, rather than methods of elasticity, can be used to evaluate stresses and displacements;
(2) The bonded components can be treated, from the standpoint of structural analysis, as elongated rectangular strips that experience linear in-plane elastic deformations;
(3) At least one of the components (“substrate”) is thick (stiff) enough so that bending deformations of the assembly as a whole do not occur and need not be considered;
(4) All the materials can be treated as linearly elastic; and
(5) The interfacial shearing stresses can be evaluated based on the concept of the interfacial compliance, without considering the effect of the “peeling” stresses (normal interfacial stresses acting in the through-thickness direction).

Let the assembly in question be subjected to both mechanical loading due to an external shearing force \check{T} and to a change in temperature Δt. Assume that the assembly was manufactured at an elevated temperature and subsequently cooled down to a low (say, room) temperature. In an approximate analysis, one could seek the longitudinal interfacial displacements, u₁(x)and u₂(x), of the assembly components #1 and #2, respectively, in the form:

$$\begin{matrix}{u}_{1} ( x ) = - {α}_{1} Δ t x + {λ}_{1} {\int }_{0}^{x} T ( ξ ) ⅆ ξ - {κ}_{1} τ ( x ) \\ {u}_{2} ( x ) = - {α}_{2} Δ t x - {λ}_{2} {\int }_{0}^{x} T ( ξ ) ⅆ ξ + {κ}_{21} τ ( x )\end{matrix} \qquad ( 1 )$$

In these equations, α₁ and α₂ are the CTEs (coefficients of thermal expansion) of the adherend materials,

$${λ}_{1} = \frac{1 - {v}_{1}}{{E}_{1} {h}_{1}} , {λ}_{2} = \frac{1 - {v}_{2}}{{E}_{2} {h}_{2}} , \qquad ( 2 )$$

are the axial compliances of the assembly components, E₁ and E₂ are the Young's moduli of the materials, v₁ and v₂ are their Poisson's ratios, h₁ and h2 are the thicknesses of the assembly components,

$$T ( x ) = x {\int }_{- l}^{x} τ ( ξ ) ⅆ ξ \qquad ( 3 )$$

are the thermally induced forces acting in the cross-sections of the assembly components, τ(x) is the interfacial shearing stress, l is half the assembly length,

$${κ}_{1} = \frac{{h}_{1}}{3 {G}_{1}} , {κ}_{2} = \frac{{h}_{2}}{3 {G}_{2}} \qquad ( 4 )$$

are the interfacial compliances of the assembly component (see E. Suhir, “Stresses in Bi-metal Thermostats,” ASME Journal of Applied Mechanics, vol. 18, No. 5, 1986), and

$${G}_{1} = \frac{{E}_{1}}{2 ( 1 + {v}_{1} )} , {G}_{2} = \frac{{E}_{2}}{2 ( 1 + {v}_{2} )} \qquad ( 5 )$$

are the shear moduli of the adherend materials. The origin, O, of the coordinate x is at the mid-cross-section of the assembly.

The first terms in the right parts of the equation (1) are unrestricted (stress free) thermal contractions. The second terms are due to the forces T(x), and are evaluated based on Hooke's law. The structure of these terms reflects an assumption that all the points of the given cross-section experience the same longitudinal displacements. The third term considers the fact that the interfacial displacements are larger than the displacements of the inner points of a given cross-section. The structure of these terms reflects an assumption that the difference between the interfacial displacement and the displacements of the inner points of the cross-section is proportional to the shearing stress in the given cross-section and is not affected by the stresses and strains in the adjacent cross-sections.

The condition of the compatibility of the longitudinal interfacial displacements (1) can be written as follows:

$$\begin{matrix}{u}_{1} ( x ) = {u}_{2} ( x ) - {κ}_{0} τ ( x ) \\ where & ( 6 ) \\ {κ}_{0} = \frac{{h}_{0}}{{G}_{0}} = 2 ( 1 + {v}_{0} ) \frac{{h}_{0}}{{E}_{0}} & ( 7 )\end{matrix}$$

is the interfacial compliance of the bonding layer for a thermally mismatched assembly, h₀ is the thickness of this layer, E₀ and v₀ are the elastic constants of the bonding material, and G₀ is its shear modulus.

Introducing equation (1) into the compatibility condition (6), we obtain the following integral equation for the interfacial shearing stress function τ(x):

$$\begin{matrix}κ τ ( x ) - λ {\int }_{0}^{x} T ( ξ ) ⅆ ξ = Δ α Δ t x , \\ where & ( 8 ) \\ κ = {κ}_{0} + {κ}_{1} + {κ}_{2} & ( 9 )\end{matrix}$$

is the total interfacial compliance of the assembly,
λ=λ₁+λ₂ (10)
is the total axial compliance of the assembly, and Δα=α₂−α₁ is the thermal contraction mismatch of the adherend materials.

Differentiating equation (8), results in:
κτ′(x)−λT(x)=ΔαΔt (11)

The next differentiation, taking into account equation (3), yields:
κτ″(x)−λτ(x)=0 (12)

The boundary conditions
T(−l)=0 T(l)=\hat{T} (13)
for the induced force can be translated into the boundary conditions for the interfacial shearing stress using the equation (11). This yields:

$${τ}^{′} ( - l ) = \frac{Δ α Δ t}{κ} , {τ}^{′} ( l ) = \frac{Δ α Δ t + λ \hat{T}}{κ} \qquad ( 14 )$$

Equation (12) has the following solution:

$$\begin{matrix}τ ( x ) = {C}_{1} sinh k x + {C}_{2} cosh k x , \\ where & ( 15 ) \\ k = \sqrt{\frac{λ}{κ}} & ( 16 )\end{matrix}$$

is the parameter of the interfacial sharing stress.

Introducing equation (15) into the boundary conditions (14), solving the obtained equations for the constants C₁ and C₂ of integration, and substituting the equations for the constants of integration into the equation (15), the following expression for the interfacial shearing stress function results:

$$τ ( x ) = k [ \frac{Δ α Δ t}{λ} \frac{sinh k x}{cosh k l} + \hat{T} \frac{cosh ( k ( x + l ) )}{sinh 2 k l} ] \qquad ( 17 )$$

The maximum value of the interfacial shearing stress occurs at the end x=l and is

$${τ}_{max} = τ ( l ) = k ( \frac{Δ α Δ t}{λ} tanh k l + \hat{T} coth 2 k l ) \qquad ( 18 )$$

In sufficiently long and/or stiff assemblies, the hyperbolic tangent and cotangent are equal to 1, and equation (18) yields:

$${τ}_{max} = τ ( l ) = k ( \frac{Δ α Δ t}{λ} + \hat{T} ) \qquad ( 19 )$$

Thus, it is the parameter k of the interfacial shearing stress that is responsible for both the level of this stress and its intensity at the assembly ends. This parameter k decreases with the decrease in the axial compliance λ of the assembly (which is due to the adherends only, for a sufficiently thin and/or low modulus bonding layer) and decreases with the increase in the assembly's interfacial compliance κ (which, for conventional assemblies with not very compliant bonding layers is typically due to both the interfacial compliance of the bonding layer and the adherends themselves). Hence, for lower interfacial shearing stress, one should design a joint with stiff (rigid) adherends and a compliant bonding layer. This will make the factor k lower, will bring down the maximum interfacial shearing stress and will spread the interfacial shearing loading over larger areas at the assembly ends. There is therefore an obvious incentive/motivation for designing assemblies with high interfacial compliance. In this connection, it should be pointed out that, although the stress model described above was developed for a situation, when all the assembly materials have the same temperature, the use of metal wires and/or metal nanoparticles and/or metal protrusions and/or wires (including nano-wires), nano-particles or protrusions made of other materials that are able to bring down the difference, if any, in temperature between the adherends, thereby reducing the thermal expansion/contraction mismatch strain. As evident from the formulas (18) and (19), the maximum value of the interfacial shearing stress is directly proportional to the thermal mismatch strain, which has therefore a strong influence on the stress level. In the case when the adherends have different temperatures, this strain is due to both different CTEs of the adherends and the temperature gradient in the through-thickness direction. Employment of metal materials in the bonding layer enables one to reduce this gradient and, hence, the interfacial stresses.

The level of stress relief that could be expected by employing an array of nanowires as a compliant attachment is assessed in the analysis that follows.

Such a bonding layer is one of the embodiments of the present invention.

Examine a bonded structure, in which the bonding layer is constructed of an array of wires, particularly, nano-wires. The wires in our analysis have circular cross-sections and are considered rigidly clamped at the inner surfaces of the adherends. Treating each of such wires as a beam clamped at its ends and experiencing the ends offset of the magnitude δ, we find, using simple methods of structural analysis, that the corresponding lateral forces at the wire ends are

$$N = \frac{12 E I δ}{{h}_{0}^{3}} = \frac{3 π}{16} \frac{E {d}^{4} δ}{{h}_{0}^{3}} \qquad ( 20 )$$

where E is the Young's modulus of the wire material, d is the wire diameter, and h₀ is the wires' height, i.e., the thickness of the bonding layer. In equation (20),

$$I = \frac{π {d}^{2}}{64}$$

is the moment of inertia of the wire cross-section. The interfacial compliance of the bonding layer in question can be found by multiplying the δ/N ratio by the wire cross-sectional area

$$A = \frac{π {d}^{2}}{4} .$$

This yields:

$${κ}_{w} = \frac{16 {h}_{0}^{3}}{3 π E {d}^{4}} \frac{π {d}^{2}}{4} = \frac{4}{3} \frac{{h}_{0}^{3}}{E {d}^{2}} \qquad ( 21 )$$

Using equation (7) for the interfacial compliance of a bonding layer made of a conventional material (such as, say, epoxy or solder), the ratio

$$η = \frac{4}{3} \frac{{G}_{0}}{E} {( \frac{{h}_{0}}{d} )}^{2} \qquad ( 22 )$$

can be used to assess the advantage of a nanowire-based bonding layer in comparison with a conventional material-based bonding layer. Let, for instance, a conventional bonding material have a shear modulus of 5000 psi, a Young's modulus of the nanowire material be E=15×10⁶ psi, the thickness of the bonding layer be h₀=50 μm, and the diameter of the nanowire be 100 nm. Then equation (22) yields: η=111. This means that a significant increase in the interfacial compliance could be expected by using a nanowire-based bonding structure, and, because the maximum interfacial shearing stress, as has been demonstrated in the previous illustrative example, is inversely proportional to the square root of the interfacial compliance, one could expect an order of the magnitude decrease in the maximum interfacial shearing stress. Although the carried out analysis was conducted for a “clamped-clamped” wire, the results are equally applicable to wires with other boundary conditions at the ends (say, for cantilever-type wires).

As has been indicated above, additional increase in the interfacial compliance could be achieved, if the wires experience (are subjected to) axial compression. In order to assess the expected effect of such a compression, examine, also as an illustration, a cantilever wire (beam) subjected at its free end to a lateral (bending) force, P, and an axial compressive force, T.

The equation of bending of such a beam is as follows:
EIw″(x)+Tw(x)=0 (23)

Here w(x) is the deflection function of the beam, and EI is its flexural rigidity. Equation (23) is, in effect, an equation of equilibrium that states that the external bending moment expressed by the second term in (23) should be equilibrated by the elastic bending moment, expressed by the first term. The origin O of the coordinate x is at the clamped end of the wire.

The following boundary conditions should be satisfied:
w(0)=0, w′(0)=0, w″(l)=0, EIw′″(l)+Tw′(l)+P=0 (24)

The first boundary condition indicates that the deflection at the clamped end should be zero. The second boundary condition indicates that the angle of rotation at the clamped end should be zero. The third boundary condition indicates that the bending moment (the wire's curvature) at the free end should be zero. The fourth boundary condition is the equation of equilibrium of all the forces acting at the free end: the elastic lateral force, the axial compressive force and the lateral external force. In order to satisfy the four conditions (24), equation (23) is differentiated twice, and the solution to the obtained differential equation of the fourth order is as follows:

$$\begin{matrix}w ( x ) = {C}_{0} + {C}_{1} k x + {C}_{2} cos k x + {C}_{3} sin k x \\ where & ( 25 ) \\ k = \sqrt{\frac{T}{E I}} & ( 26 )\end{matrix}$$

is the parameter of the compressive force. Introducing the sought solution (25) into the boundary conditions (24), the following equations for the constants of integration are obtained:

$${C}_{0} = - {C}_{2} = \frac{P}{k T} tan k l , {C}_{1} = - {C}_{3} = - \frac{P}{k T} \qquad ( 27 )$$

and the solution (25) results in the following expression for the deflection function:

$$w ( x ) = \frac{P}{k T} [ tan k l - k x - \frac{sinh ( k ( l - x ) )}{cosh k l} ] \qquad ( 28 )$$

The maximum deflection at the wire end is

$$w ( l ) = \frac{P}{k T} ( tan k l - k l ) \qquad ( 29 )$$

The maximum deflection at the free end of a cantilever beam subjected to a lateral force P applied at this end is

$$δ = \frac{P {l}^{3}}{3 E I} \qquad ( 30 )$$

Comparing equations (29) and (30), parameter ζ

$$= 3 \frac{tan k l - k l}{{( k l )}^{3}} \qquad ( 31 )$$

considers the effect of the axial compression on the lateral compliance of a cantilever wire. This parameter ζ is infinitely large, when the compressive force, T, reaches its critical (Euler) value. Indeed, the requirement kl→∞ leads to the requirement kl→π/2, and equation (26) yields

$$T = \frac{{π}^{2} E I}{4 {l}^{2}} ,$$

which is a well known expression for a critical force for a cantilever beam. But even when the parameter kl is only kl=0.866, equation (31) is already as high as about 6.4, and a 2.5 fold decrease in the interfacial shearing stress could be expected. Thus, there is a definite incentive, as far as the interfacial shearing stress is concerned, for using nanowire-based bonding structures subjected to compression.

This compression cam be achieved by application of external forces, but it certainly can stem from the bonding compound features, as quantitatively shown below.

The surface area of the compound material located between the bounded surfaces is:
S=S1+S2 (32)
where S1 is the surface of the contact of the compound material with the bonded areas, and S2 is the “exposed”-to-air lateral surface of the compound material, i.e., the surface of the compound material, which is in direct contact with air, in contact with air. It is clear that

$$\begin{matrix}S 1 = 2 π {R}^{2} \\ S 2 = {\int }_{\frac{π}{2}}^{\frac{π}{2}} 2 π \cdot ( R + \frac{d}{2} \cdot Cos ( α ) ) \cdot \frac{d}{2} ⅆ α = π \cdot ( π \cdot R + d ) \cdot d\end{matrix} \qquad ( 33 )$$

The volume of the compound bonding material is

$$V = π \cdot d \cdot ( \frac{{d}^{2}}{6} + \frac{π \cdot R \cdot d}{6} + {R}^{2} ) \\ or \\ 6 \cdot {( \frac{R}{ρ} )}^{2} \cdot \frac{d}{ρ} + π \cdot \frac{R}{ρ} \cdot {( \frac{d}{ρ} )}^{2} + {( \frac{d}{ρ} )}^{3} = 8 \qquad ( 34 )$$

Here, the volume of a drop of the compound bonding material is

$$V = \frac{4}{3} \cdot π \cdot {ρ}^{3} \qquad ( 35 )$$

The volume of the compound material should be the same during its deformation between the two bonding surfaces and, therefore, can be considered to be constant, as it should be for a non-compressible material. For the sake of simplicity of the calculation, consider an initially spherical drop of the compound of radius ρ. This corresponds to the case of zero contact area.

If we define R and d in units of ρ, then the equation (34) becomes
6R²d+πRd²+d³=8 (36)

The only real solution to this cubic equation for d is:

$$d ( R ) = \sqrt[3]{4 + [ π - {( \frac{π}{3} )}^{3} ] {R}^{3} + \sqrt{( 8 - \frac{ {π}^{ 2}}{ 3} ) \cdot {R}^{ 6} + π \cdot ( 8 - \frac{8}{ 27} \cdot {π}^{ 2} ) \cdot {R}^{ 3} + 16}} - \frac{( 2 - \frac{{π}^{2}}{9} ) \cdot {R}^{2}}{\begin{matrix}\sqrt[3]{4 + [ π - {( \frac{π}{3} )}^{3} ] {R}^{3} + π \cdot ( 8 - \frac{{π}^{2}}{3} ) \cdot } \\ {R}^{ 6} + π \cdot ( 8 - \frac{8}{ 27} \cdot {π}^{ 2} ) \cdot {R}^{ 3} + 16\end{matrix}} - \frac{1}{3} \cdot π \cdot R \qquad ( 37 )$$

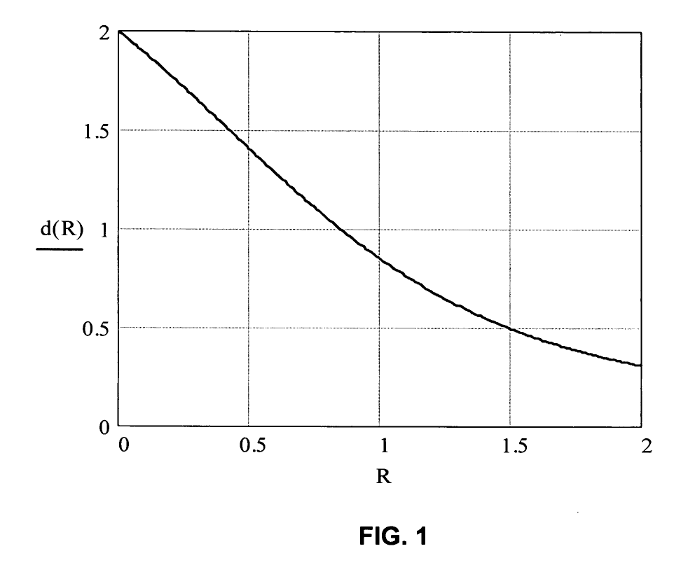

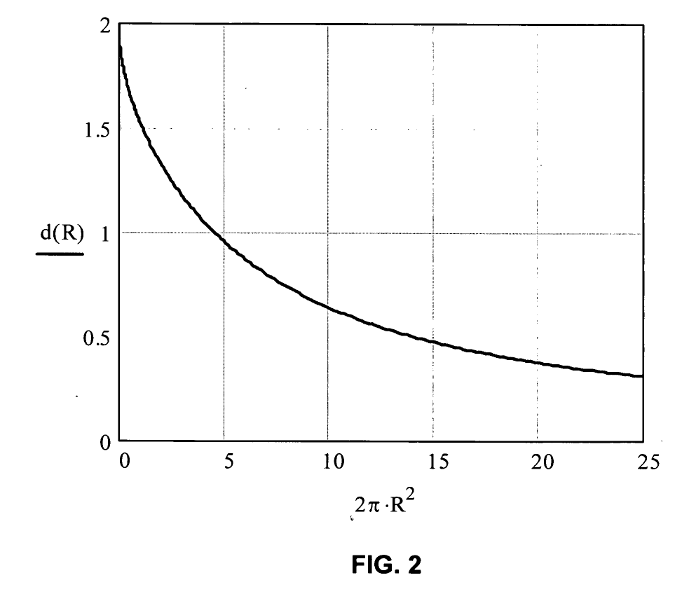

The plot of this dependence is shown in FIG. 1. A similar plot for the space between the bonded surfaces vs. bond contact area S1 is shown in FIG. 2.

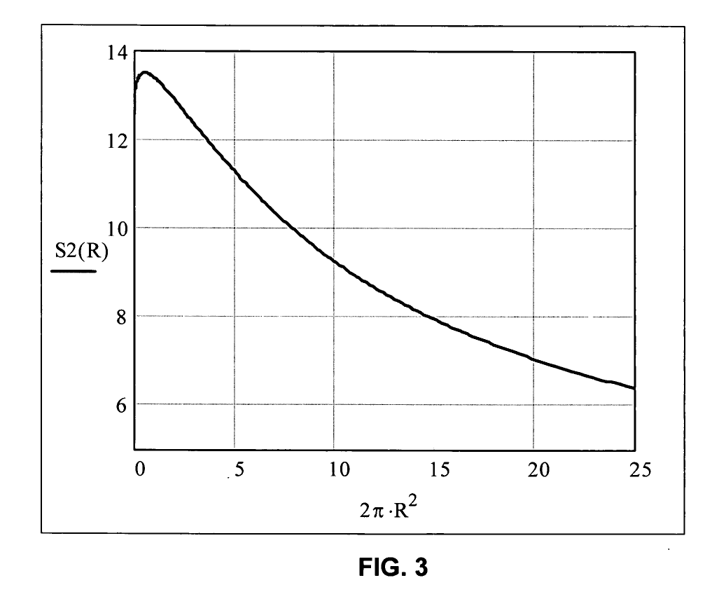

The compound-air area S2 vs. bond-surface are S1 is shown in the plot of FIG. 3. Suppose that the compound-bonded coefficient of surface tension is k-times lower than the compound-air surface tension coefficient—σ_{ca}

$${σ}_{cb} = \frac{{σ}_{ca}}{k} \qquad ( 38 )$$

Then the elastic energy associated with the surface energy of the compound can be written in the following form:

$${E}_{p} = S 1 \cdot {σ}_{cb} + S 2 \cdot {σ}_{ca} = ( S 1 + S 2 ) \cdot {σ}_{ca} - S 1 \cdot ( {σ}_{ca} - {σ}_{cb} ) \\ or \\ {E}_{p} = {σ}_{ca} \cdot ( S 1 + S 2 - S 1 \cdot ( 1 - \frac{1}{k} ) ) \qquad ( 39 )$$

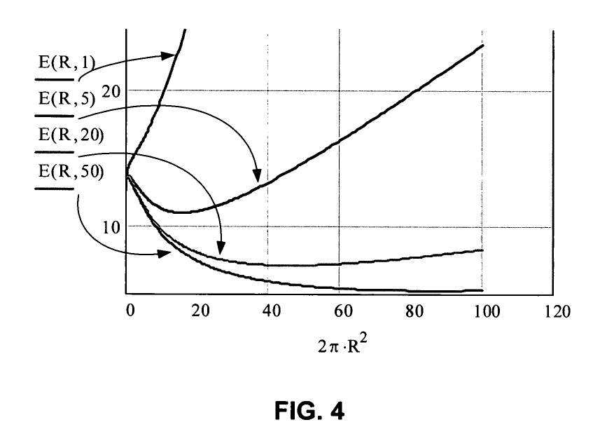

The energy relationships are plotted for different k-values in FIG. 4. Note in particular that curve E(R,1) cannot be used as a bonding material, since it represents a repulsive force. Curves E(R,20) and E(R,50) can be used as a bonding material, but not as a compliant one. Curve E(R,5) has a local minimum, which represents the minimum energy state (equilibrium) that the system tries to attain. This curve therefore represents an example of a compliant bonding material.

It should be pointed out that for all the k values exceeding 1, there is an energy minimum making the system's behavior non-linear, yet elastic (see FIG. 4). As an elastic system (actually, visco-elastic system in this case), this system tries to achieve a state of equilibrium that corresponds to the minimum of the elastic energy associated with surface tension. The left portion of the corresponding curve (preceding its minimum value) corresponds to the situation when the interaction of the bonded surfaces are attracted to each other, while the right portions of the energy curves correspond to distraction forces. This means that the actual structure should be designed in such a way that the parameter k is adequately evaluated and established. Then the system will operate in the condition of a dynamic steady-state (stable) equilibrium with the “distractive” reactive forces caused by the compressed nanowires.

Another way of increasing the compliance of the bonding layer is to use a combination of a “smart” structure and a “smart” material with thixotropic properties, i.e., a material that is able to reduce dramatically its viscosity when subjected to shearing stress. The thixotropy of this material is due the use of nanoparticles. This approach can be used instead of using nanowires, or in addition to it.

Having thus described a preferred embodiment, it should be apparent to those skilled in the art that certain advantages of the described method and apparatus have been achieved. It should also be appreciated that various modifications, adaptations, and alternative embodiments thereof may be made within the scope and spirit of the present invention. The invention is further defined by the following claims.

### BIBLIOGRAPHY

U.S. Patents:

Martin et al., “Compliant Diaphragm Material,” U.S. Pat. No. 4,837,068.
Kovac et al., “Compliant Interface for Semiconductor Chip and Method Therefor,” U.S. Pat. No. 6,133,639.
Ingman et al., “Optical Fiber with Nanoparticle Cladding,” Published U.S. Patent Application No. 20030026584.
Suhir, “Device and Method of Controlling the Bowing of a Soldered or Adhesively Bonded Assembly,” U.S. Pat. No. 6,239,382.
DiStefano et al., “Compliant Microelectronic Mounting Device,” U.S. Pat. No. 6,370,032.
Suhir, “Bi-Material Assembly Adhesively Bonded at the Ends and Fabrication Method,” U.S. Pat. No. 6,460,753.
Suhir, “Coated Optical Glass Fiber,” U.S. Pat. No. 6,647,195.
Kovac et al., “Methods for Making Electronic Assemblies Including Compliant Interfaces,” U.S. Pat. No. 6,525,429.
Ingman et al., “Moisture Resistant Nanoparticle Material and Its Applications,” PCT Application No. PCT/US03/18688 (filed 13 Jun. 2003)
Paterson et al., “Mechanical Highly Compliant Thermal Interface Pad,” U.S. Pat. No. 6,910,271.
Kovac et al., “Methods of Making Microelectronic Assemblies Including Compliant Interfaces,” U.S. Pat. No. 6,870,272.
   Other Publications
E. Suhir, “Structural Analysis in Microelectronic and Fiber Optic Systems,” vol. 1, Basic Principles of Engineering Elasticity and Fundamentals of Structural Analysis,” Van Nostrand Reinhold, New York, 1991.
E. Suhir, “Mechanics of Coated Optical Fibers: Review and Extension,” ECTC'2005, Orlando, Fla., 2005.
E. Suhir, “Microelectronic and Photonic Systems: Role of Structural Analysis,” InterPack'2005, San Francisco, July 2005.
E. Suhir, “New Nanoparticle Material (NPM) for Micro- and Opto-Electronic Packaging Applications,” IEEE Workshop on Advanced Packaging Materials, Irvine, March 2005.
E. Suhir, “Polymer Coated Optical Glass Fiber Reliability: Could Nano-Technology Make a Difference?” Polytronic '04, Portland, Oreg., Sep. 13-15, 2004.
E. Suhir, “Thermal Stress in an Adhesively Bonded Joint with a Low Modulus Adhesive Layer at the Ends,” Applied Physics Journal, April 2003.
E. Suhir, “Thermal Stress Modeling in Micro- and Opto-Electronics: Review and Extension,” Invited Presentation, ASME Symposium Dedicated to Dr. Richard Chu, IBM, Washington, D.C., November 2003.
E. Suhir, “Polymer Coated Optical Glass Fibers: Review and Extension,” Proceedings of the POLYTRONIK'2003, Montreaux, Oct. 21-24, 2003.
E. Suhir, “Analytical Stress-Strain Modeling in Photonics Engineering: Its Role, Attributes and Interaction with the Finite-Element Method,” Laser Focus World, May 2002.
E. Suhir, “Thermal Stress in a Polymer Coated Optical Glass Fiber with a Low Modulus Coating at the Ends,” Journal of Materials Research, vol. 16, No. 10, 2001.
E. Suhir, “Thennomechanical Stress Modeling in Microelectronics and Photonics,” Electronic Cooling, vol. 7, No. 4, 2001.
E. Suhir, “Thermal Stress in a Bi-Material Assembly Adhesively Bonded at the Ends,” Journal of Applied Physics, vol. 89, No. 1, 2001.
E. Suhir, “Thermal Stress Modeling in Microelectronics and Photonics Packaging, and the Application of the Probabilistic Approach: Review and Extension,” IMAPS International Journal of Microcircuits and Electronic Packaging, vol. 23, No. 2, 2000 (invited paper)
E. Suhir, “Modeling of the Mechanical Behavior of Microelectronic and Photonic Systems: Attributes, Merits, Shortcomings, and Interaction with Experiment,” Proceedings of the 9th Int'l. Congress on Experimental Mechanics, Orlando, Fla., Jun. 5-8, 2000
E. Suhir, “Silica Optical Fiber Interconnects: Design for Reliability,” Proceedings of the Annual Conference of the American Ceramic Society, St. Louis, Mo., May 3, 2000
E. Suhir, “Adhesively Bonded Assemblies with Identical Nondeformable Adherends and “Piecewise Continuous” Adhesive Layer: Predicted Thermal Stresses and Displacements in the Adhesive,” Int'l. Journal of Solids and Structures, vol. 37, 2000
E. Suhir, “Thermal Stress Failures in Microelectronics and Photonics: Prediction and Prevention,” Future Circuits International, issue 5, 1999
E. Suhir, “Adhesively Bonded Assemblies with Identical Nondeformable Adherends: Predicted Thermal Stresses in the Adhesive Layer,” Composite Interfaces, vol. 6, No. 2, 1999
E. Suhir, “Adhesively Bonded Assemblies with Identical Nondeformable Adherends and Nonhomogeneous Adhesive Layer: Predicted Thermal Stresses in the Adhesive,” Journal of Reinforced Plastics and Composites, vol. 17, No. 14, 1998
E. Suhir, “Fiber Optic Structural Mechanics—Brief Review,” Editor's Note, ASME Journal of Electronic Packaging, September 1998.
E. Suhir, “Predicted Thermal Mismatch Stresses in a Cylindrical Bi-Material Assembly Adhesively Bonded at the Ends,” ASME Journal of Applied Mechanics, vol. 64, No. 1, 1997.
E. Suhir, “Approximate Evaluation of the Interfacial Shearing Stress in Circular Double Lap Shear Joints, with Application to Dual-Coated Optical Fibers,” Int'l. Journal of Solids and Structures, vol. 31, No. 23, 1994.
E. Suhir, “Buffering Effect of Fiber Coating and Its Influence on the Proof-Test Load in Optical Fibers,” Applied Optics, vol. 29, No. 18, 1990.
E. Suhir, “Interfacial Stresses in Bi-Metal Thermostats,” ASME Journal of Applied Mechanics, vol. 56, No. 3, September 1989.
E. Suhir, “Calculated Stresses in Dual-Coated Fibers,” Proc. of the SPE 46th Annual Technical Conference, ANTEC '88, Atlanta, Ga., May 1988.
E. Suhir, “Calculated Thermally Induced Stresses in Adhesively Bonded and Soldered Assemblies,” Proc. of the Int'l. Symp. on Microelectronics, ISHM, 1986, Atlanta, Ga., October 1986.
E. Suhir, “Stresses in Bi-Metal Thermostats,” ASME Journal of Applied Mechanics, vol. 53, No. 3, September 1986.

What is claimed is:

1. A bonding material comprising:
a thixotropic filler; and
a plurality of nanoparticles embedded in the filler,
wherein the material is a compliant bonding material.

2. The bonding material of claim 1, wherein the nanoparticles comprise any of Ag, Cu, Ti, Ni, metal oxides, silica, ZnO and Fe₂O₃.

3. The bonding material of claim 1, wherein the filler comprises any of polysiloxane, siloxane and silicone oil.

4. The bonding material of claim 1, wherein the filler comprises a stable viscous liquid.

5. A bonding material comprising:
a thixotropic filler; and
a plurality of microspheres embedded in the filler; and
a plurality of whiskers on surfaces of the microspheres.

6. The bonding material of claim 5, further comprising nanoparticles embedded in the filler.

7. The bonding material of claim 5, wherein the whiskers are any of nanotubes, nanoparticles and nanowires.

8. The bonding material of claim 5, wherein the whiskers are metallic.

9. A bonded structure comprising:
a first surface;
a second surface;
a thixotropic compliant bonding material between the first and second surfaces, wherein the bonding material comprises nanoparticles.

10. A bonded structure comprising:
a first surface;
a second surface;
a substrate between the first and second surfaces, the substrate having any of nanowires and nanotubes formed on at least one side, the any of nanowires and nanotubes being in contact with the first and second surfaces.

11. The structure of claim 10, wherein the any of nanotubes and nanowires are subjected to axial compression.

12. The structure of claim 11, wherein the axial compression is due to an externally applied force.

13. The structure of claim 11, wherein the axial compression is due to a difference in surface tension coefficients between the compound-air and compound-bonded interfaces.
